(19) United States
(12) Patent Application Publication
(10) Pub. No.: US 2015/0291366 A1
(43) Pub. Date: Oct. 15, 2015

(54) Idler

(71) Applicant: John Pear CUMBERLEGE, (US)

(72) Inventor: John Pear Cumberlege, Alberton (ZA)

(21) Appl. No.: 14/441,584

(22) PCT Filed: Nov. 8, 2013
(86) PCT No.: PCT/ZA2013/000082

§ 371 Date: May 8, 2015

(30) Foreign Application Priority Data
Nov. 8, 2012 (ZA) 2012/08398

(51) Int. Cl. B65G 39/071; B65G 39/16

(52) U.S. Cl. CPC B65G 39/071; B65G 39/16

(57) ABSTRACT

This invention relates to an idler. More specifically, the invention relates to any type of tracking idlers or pulleys (also known as trainer idlers or pulleys) typically used in the application of conveyors for the purposes of guiding a travelling conveyor belt to follow a central path. The idler, for guiding a travelling conveyor belt to that the belt follows a central path, includes a support axle (14), a steering roller (12), a pivot means and a castellated formation of alternating ridges (20) and grooves (22) having specific ranges of amongst other, groove width to enable portions of the conveyor belt to sag there into for the purposes of increasing the steering action of the idler on the conveyor belt.

### BACKGROUND OF THE INVENTION

THIS invention relates to an idler. More specifically, the invention relates to any type of tracking idlers or pulleys (also known as trainer idlers or pulleys) typically used in the application of conveyors for the purposes of guiding a travelling conveyor belt to follow a central path.

As such, reference to the term “idler” in this specification will be understood to include idlers or pulleys that transmit no power but that generally guide or stretch a conveyor belt, as well as idlers or pulleys that transmit power such as a drive pulley.

It is well known that conveyor belts tend to drift or creep sideways as they travel along their intended paths. This problem is exacerbated when the belt is particularly long, carries high load, or is a particularly heavy belt. When setting up the belt it is known practice to adjust the alignment of either the drive roller or return roller, or both, to try and achieve central tracking of the belt. However, the belt will often tend to shift laterally at some intermediate point along its length which can cause damage to the edge of the belt or to the idler support frame and/or conveyor support structure.

Also, in use, a belt that has originally been set up to track centrally may, after time, begin to move laterally due to belt stretch, high load situations, or deposits on the idlers. For this reason it is standard practice to have an operator continuously adjusting the angle of the drive or return roller to try and achieve central tracking of the belt. High cost automatic pneumatic or hydraulic adjustors are known, but these are not always appropriate to use, particularly in high load mining operations.

To avoid this continual adjustment it is also known to install tracking idlers, which are also known as training idlers, along the length of the conveyor which will automatically slew about a vertical axis as the belt moves out of alignment to steer the belt back to its central path, as taught for example by U.S. Pat. No. 5,911,304, depicting a relatively inexpensive and uncomplicated idler that needs no special maintenance or skilled operator to install and maintain it.

Although these types of known idlers appear to work well in practice, it is envisaged that certain improvements and/or modifications may be made to known tracking idlers to substantially increase their steering action on the conveyor belts.

Accordingly, it is an object of the present invention to provide an improved and/or modified idler with increased steering action acting on a conveyor belt to keep it travelling on a central path.

### SUMMARY OF THE INVENTION

According to the invention there is provided an idler for guiding a travelling conveyor belt so that the belt follows a central path, the idler including:
a support axle mountable to a conveyor support structure;
a steering roller rotatably mounted on the support axle so as to be rotatable about a rotational axis thereof;
a pivot means defining a pivot axis about which the rotational axis of the steering roller is pivotally displaceable so as to in use enable the steering roller to impart a steering action upon the conveyor belt to return it to the central path in the event of the conveyor belt drifting laterally from the central path;
wherein a radial periphery of the idler in radial cross-section is castellated to define axially alternating ridges and grooves with the axial distance spanning across a respective groove, and as measured between proximate apexes of adjacent ridges, representing the groove width of such groove; and
further wherein the groove width falls within one of the following Groove Width Ranges:
   Groove Width Range A, being between about 20 and 50 millimetres;
   Groove Width Range B, being between about 40 and 50 millimetres;
   Groove Width Range C, being between about 50 and 70 millimetres;
   Groove Width Range D, being between about 70 and 100 millimetres;
   Groove Width Range E, being between about 100 and 150 millimetres; or
   Groove Width Range F, being between about 150 and 200 millimetres;
so as to in use cause the conveyor belt to at least partially sag into each of the grooves, thereby to increase the steering action of the steering roller on the conveyor belt.

Preferably, the radial distance between the apex of a respective ridge and the radially inner most surface of a respective groove represents the groove depth, the groove depth falling within one of the following Groove Depth Ranges:
Groove Depth Range A, being between about 15 and 20 millimetres; or
Groove Depth Range B, being between about 10 and 15 millimetres.

Typically, the distance spanning between the apexes of a respective ridge, as measured axially along the radial periphery of the idler in radial cross-section, represents the ridge width, the ratio of groove width to ridge width being within a range of about between 1:1 to 6:1.

Generally, the summed distance of the ridge widths of each of the ridges combined is 35% to 55% of the width of the conveyor belt to be supported in use thereon.

It will be appreciated that idlers having a groove width falling within:
Groove Width Range A are typically used for supporting the load carrying side of conveyor belts having a thickness of 8 to 12 millimetres;
Groove Width Range B are typically used for supporting conveyor belts having a thickness of 8 to 12 millimetres;
Groove Width Range C are typically used for supporting conveyor belts having a thickness of 12 to 16 millimetres;
Groove Width Range D are typically used for supporting conveyor belts having a thickness of 16 to 22 millimetres;
Groove Width Range E are typically used for supporting conveyor belts having a thickness of 22 to 40 millimetres; and
Groove Width Range F are typically used for supporting conveyor belts having a thickness of 30 to 50 millimetres.

Typically, the idlers with groove widths falling within Groove Width Range A to F are used for supporting the return side of conveyor belts.

It will be appreciated further that idlers having a groove width falling within:
Groove Depth Range A are typically used for supporting conveyor belts having a thickness of 8 to 20 millimetres; and
Groove Depth Range B are typically used for supporting conveyor belts having a thickness of 20 to 50 millimetres.

In a first alternative embodiment of the invention, the pivot means may be external from the idler or idlers such that the support axle is mounted on a support frame to form an idler assembly, with the idler assembly in use being mountable on the conveyor support structure. Generally, the pivot means is connected between the support axle and the support frame such that the support axle, and consequently the rotational axis of the idler or idlers, is pivotally displaceable relative to the support frame. In this manner, the rotational axis of the idler or idlers is in use pivotally displaceable relative to the conveyor support structure and the conveyor belt so as to impart the steering action thereon.

In respect of the first alternative embodiment, the pivot means may be a pivot shaft on which the support axle is pivotally displaceable relative to the support frame.

In a second alternative embodiment of the invention, also comprising a pivot means located externally of the steering roller, the support axle may be mounted on a support frame to form an idler assembly, with the support frame mountable in use on the conveyor support structure such that the pivot means is connectable between the support frame and the conveyor support structure to enable in use the support frame, and consequently the support axle and the rotational axis of the idler or idlers, to pivotally displace relative to conveyor support structure and the conveyor belt.

In respect of the second alternative embodiment, the pivot means may be a pivot shaft on which the support frame is pivotally displaceable relative to the conveyor support structure.

It will be appreciated that the idler may be more than one idler supported on more than one support axle to form for example, a toughing idler assembly for the load carrying side of a conveyor.

In yet a third preferred embodiment, the pivot means may be internal of the steering roller. Preferably, the steering roller comprises a inner hollow cylindrical sleeve and an outer hollow cylindrical sleeve, the outer sleeve being rotatably mounted on the inner sleeve on bearings located near axial ends of the steering roller, wherein the pivot means is a pivot shaft pivotally connecting the inner sleeve to the support axle at a location coinciding with the axial mid-point of the inner sleeve and the support axle, such that the inner sleeve and the support axle are pivotally displaceable relative to one another about the pivot shaft.

Generally, the pivot shaft is connected diametrically across the inner sleeve and passes through a pivot shaft receiving aperture defined in the support axle. Preferably, the pivot shaft is fixed in the pivot shaft receiving aperture, with its axial ends received within bushes or bearings mounted diametrically opposite one another on the inner sleeve.

The pivot shaft may be mounted in use such that it is orientated substantially perpendicularly with respect to the direction of travel of the conveyor belt thereby enabling the rotational axis of the steering roller to pivotally displace about the pivot shaft between a first transverse position and a second displaced position.

In the first transverse position, the rotational axis is in use substantially transverse the direction of travel of the conveyor belt to maintain travel of the conveyor belt substantially along the central path.

In the second displaced position, the rotational axis is displaced from the first transverse position and urged toward the first transverse position through the steering action of the pivoting steering roller and the sagging of the conveyor belts into the grooves defined thereon. Typically, the pivot shaft is orientated angularly backwardly from the direction of travel of the conveyor belt by 90 degrees such that the rotational axis of the steering roller is pivotally displaceable across a plane being substantially parallel to the direction of travel of the conveyor belt.

In a preferred orientation, the pivot shaft is in use orientated angularly backwardly from the direction of travel of the conveyor belt by between about 120 and 130 degrees such that the rotational axis of the steering roller is pivotally displaceable to enable each of the axial ends of the steering roller to move operatively downwards, forwards and pivotally inwardly towards the central path of the conveyor belt, or operatively upwards, backwards and pivotally inwardly towards the central path of the conveyor belt to steer the conveyor belt towards the central path.

In use, a conveyor belt drifting to the operatively left side of the central path will cause a higher weight distribution between the axial mid-point of the steering roller and its operatively left axial end as compared to the weight distribution between the axial mid-point of the steering roller and its opposite operatively right axial end.

The imbalance in weight distributions, and the backwardly angled pivot shaft, will cause the operatively left axial end of the steering roller to pivot operatively downwards and consequently operatively forwardly and inwardly towards the operatively right-hand side to steer the conveyor belt in a operatively right direction towards the central path.

It will appreciated that the reverse will occur where the conveyor belt drifts to the right and that conveyor belt will travel along the central path with the weight distribution spread out evenly across the axial span of the steering roller.

It will be appreciated further that the steering action imparted by the steering roller on the conveyor belt via its pivotal displacement is enhanced by the sagging of the conveyor belt into the grooves defined in the steering roller, in that a significant lateral drift of the conveyor belt would in practice be required to dislodge a respective sagged portion of the conveyor belt from its respective groove forcing that sagged portion to run true within the groove.

Furthermore, the weight of a sagged portion of the conveyor belt spanning across a respective groove between points of contact on adjacent ridges is split at each point of contact into a vertical weight component and a horizontal weight component, the horizontal weight components at each of the points of contact acting on the sagged portions of the conveyor belt in opposite axial directions towards one another, thereby forcing the sagged portions of the conveyor belt to remain in the groove.

The alternating ridge and/or groove constellations on the idler in radial cross-section may arise from the application of many different patterns applied to the outer surface of the steering roller.

For example, the alternating ridges on the idler in radial cross-section are adjacent raised portions of a crest formation spiralling about the steering roller, the crest spiralling from the axial centre of the steering roller in opposing directions towards the axial ends thereof.

Alternatively, the alternating ridges on the idler in radial cross-section are adjacent raised portions of a plurality of protuberances protruding radially outwardly from the steering roller and aligned relative to one another to spiral about the steering roller to provide the steering roller with a stippled pattern. Typically, the protuberances spiral from the axial centre of the steering roller in opposing directions towards the axial ends thereof.

In another example, the alternating ridges on the idler in radial cross-section are adjacent raised portions of a plurality of annular crest formations spaced axially along the steering roller. Preferably, the annular crest formations lie on a perpendicular crest plane being substantially at right-angles with the rotational axis of the steering roller such that the perpendicular crest planes of the respective annular crest formations are parallel relative to one another.

Alternatively, the annular crest formations lie on an inclined crest plane being angularly displaced relative to the rotational axis of the steering roller by some acute angle. Furthermore, the steering roller may be configurable with annular crest formations on varying inclined annular crest planes such that adjacent annular crest formations, in radial cross-section of the idler, taper towards and/or away from one another.

The annular crest formations may be continuous formations, or alternatively define breaks there along to create in each annular crest formation a plurality of protuberances aligned annularly to provide the steering roller with a stippled pattern.

The castellated alternating ridges and grooves is applied to the steering roller as a lagging, moulded and bonded thereto or secured thereto via connecting channels fixed to the steering roller. Alternatively, the lagging is securable to the connecting channels via corresponding securing formations on the lagging and the channels.

In a preferred embodiment, the castellated alternating ridges and grooves is applied to the steering roller as a lagging, the lagging being in the form of a plurality of individual ring-shaped members each defining wholly and/or partially a ridge formation and/or a groove formation, the individual ring-shaped members being receivable over the steering roller and arranged in axially abutting relationship with respect to one another so as to jointly define the castellated alternating ridges and grooves.

The castellated alternating ridges and grooves, be it integral with the steering roller or applied thereto as a lagging, are preferably resiliently flexible for allowing compression and decompression of at least the castellated alternating ridges thereby to in use enable grit and grim release from the grooves with the conveyor belt passing thereover.

Typically, the castellated alternating ridges and grooves are formed from a rubber-like material, having a coefficient of friction for in use providing sufficient traction between the alternating ridges and the conveyor belt in wet and dry conditions, the grooves acting to exhaust moisture from between the idler and the conveyor belt. Preferably, the rubber-like material has a shore hardness of between about 50 and 60.

It will be appreciated that the idler may be one or more load carrying side idlers, a return side idlers, one or more idlers on a trough idler assembly, a tracking idler, a head pulley, a tail pulley, a drive pulley or any other pulley or idler normally used in the application of conveyors.

The shape of the ridges and/or grooves in radial cross-section of the idler may take any number of shapes, but typically substantially quadrangular or triangular. Preferably, the shape of the grooves in radial cross-section of the idler is substantially U-shaped or V-shaped.

According to a second aspect of the invention, there is provided an idler for guiding a travelling conveyor belt so that the belt follows a central path, the idler including:
a support axle mountable to a conveyor support structure;
a steering roller rotatably mounted on the support axle so as to be rotatable about a rotational axis thereof;
wherein a radial periphery of the idler in radial cross-section is castellated to define axially alternating ridges and grooves with the axial distance spanning across a respective groove, and as measured between proximate apexes of adjacent ridges, representing the groove width of such groove; and
further wherein the groove width falls within one of the following Groove Width Ranges:
   Groove Width Range A are typically used for supporting the load carrying side of conveyor belts having a thickness of 8 to 12 millimetres;
   Groove Width Range B are typically used for supporting conveyor belts having a thickness of 8 to 12 millimetres;
   Groove Width Range C are typically used for supporting conveyor belts having a thickness of 12 to 16 millimetres;
   Groove Width Range D are typically used for supporting conveyor belts having a thickness of 16 to 22 millimetres;
   Groove Width Range E are typically used for supporting conveyor belts having a thickness of 22 to 40 millimetres; and
   Groove Width Range F are typically used for supporting conveyor belts having a thickness of 30 to 50 millimetres.
so as to in use cause the conveyor belt to at least partially sag into each of the grooves, thereby to create in use a steering action acting on the conveyor belt by the steering roller to maintain travel of the conveyor belt on the central path.

### BRIEF DESCRIPTION OF THE DRAWINGS

The invention will now be described in more detail, by way of example only, with reference to the accompanying drawings in which:

FIG. 1 shows an isometric view of an idler in accordance with the invention;

FIG. 2 shows a cross-sectional side view of the idler of FIG. 1 viewed along line A-A;

FIG. 3 shows a side view of the idler of FIG. 1;

FIG. 4 shows an isometric view of a ring-shaped lagging member;

FIG. 5A-D shows an idler with alternate ridge and groove patents applied thereto;

FIG. 6 shows a schematic top view the idler in operation relative to a conveyor belt;

FIG. 7 shows a side view of the operating idler of FIG. 6;

FIG. 8 shows a front view of a first alternative embodiment of the idler;

FIG. 9 shows a front view of a second alternative embodiment of the idler; and

FIG. 10 shows a front view of the operating idler of FIGS. 6 and 7.

FIG. 11 shows a front view of the operating idler in a trough idler assembly configuration for the load carrying side of a conveyor.

### DETAILED DESCRIPTION OF THE DRAWINGS

An idler according to a preferred embodiment of the invention is designated generally with reference numeral 10 in the accompanying figures.

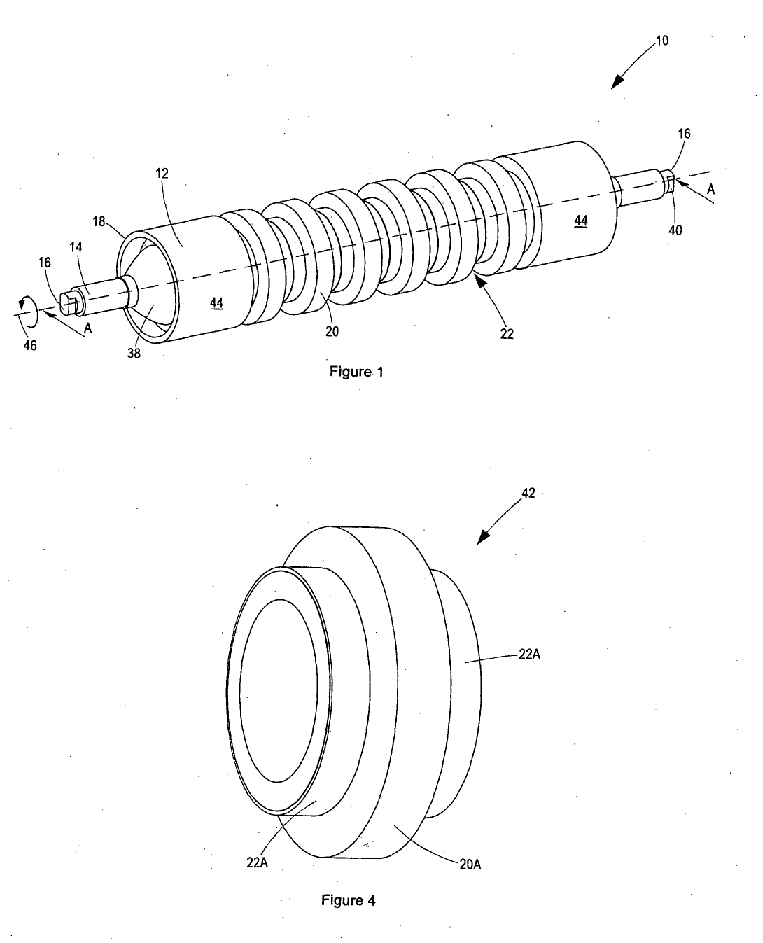

With reference to FIG. 1, the idler 10 comprises a steering roller 12 which is rotatably mounted on a support axle 14, the ends 16 of the support axle 14 extending beyond the axial ends 18 of the steering roller 12. The support axle 14 is intended to be mounted to a support frame for the conveyor belt assembly. The steering roller 12 is preferably made from or covered with a long wearing non-slip material.

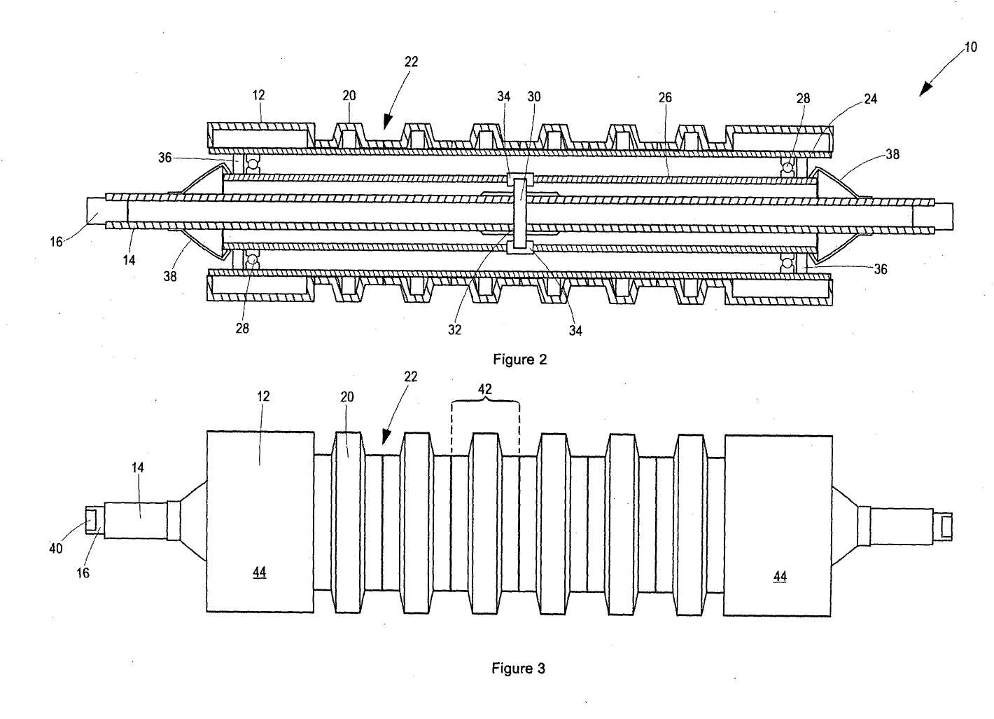

With reference now also to FIG. 2, showing a radial cross-section of the idler 10 along line A-A, the steering roller 12 comprises a castellated radial periphery defining axially alternating ridges 20 and grooves 22. The steering roller 12 is made up of an outer hollow cylindrical sleeve 24 rotatably mounted on an inner hollow cylindrical sleeve 26 on bearing 28.

The inner sleeve 26 is pivotally connected to the support axle 14 by a pivot means, the pivot means comprising a pivot shaft 30 passing through a pivot shaft receiving aperture 32 to extend diametrically across the inner sleeve 26. The pivot shaft 30 is preferably fixed in the pivot shaft receiving aperture 32 with its opposing axial ends pivotally received within bushes or bearings 34 mounted diametrically opposite one another on the inner sleeve 26.

To prevent the ingress of dirt and grime entering the outer sleeve 24 and/or the inner sleeve 26, the respective ends thereof are sealed with seals 36 and sealing boots 38. Flat surfaces 40 are machined into the axial ends 16 of the support axle 14 so as to provide an installed with a visual means of establishing the pivot axis about which the support axle 14 is pivotally displaceable relative to the inner sleeve 26 on pivot shaft 30.

With reference now also to FIG. 3 and FIG. 4, although the castellated formation may be applied to the steering roller 12 in many different ways, it is typically done so by applying a lagging, preferably in the form of individually replaceable ring-shaped members 42 fitted over the outer sleeve 24 into axially abutting engagement with one another to jointly form the alternating ridges 20 and grooves 22.

Each of the ring-shaped members 42 define a ridge formation 20A intermediate a pair of groove formations 22A. With the required number of ring-shaped members 42 fitted over the outer sleeve 24 in the required configuration, end rings 44 are applied to each of the axial ends 18 of the steering roller 12.

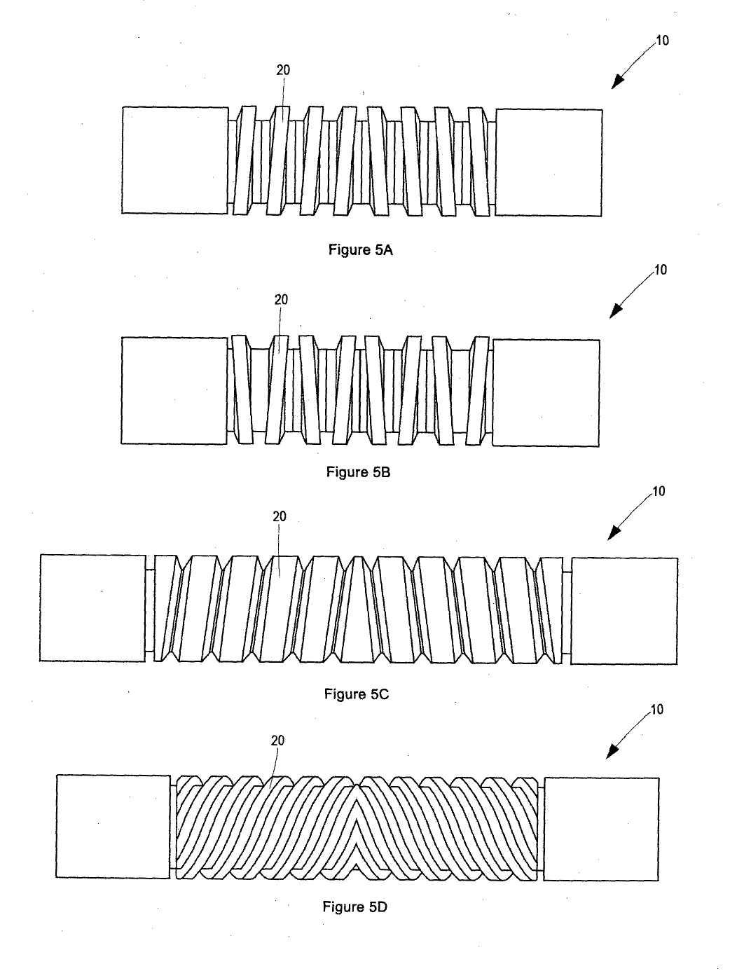

It will be appreciated that the castellation applied to the idler 10 illustrated in FIG. 3 may take many different forms as is illustrated in FIG. 5A to 5D. The ridges 20 of the idler 10 as depicted in FIG. 3 are a plurality of adjacent and parallel annular crest formations. It will be appreciated, with reference now also to FIGS. 5A to 5D that instead of lying, relative to an longitudinal axis of the steering roller 12, on a perpendicular crest plane, the ridges 20 (or adjacent annular crest formations) may lie on an inclined crest plane being angularly displaced relative to the longitudinal axis of the steering roller 12 by some acute angle.

In yet a further embodiment as illustrated in FIG. 5D, ridges 20 may be adjacent raised portions of a crest formation spiralling about the steering roller 12, the crest spiralling from the axial centre of the steering roller 12 in opposing directions towards the axial ends 18 thereof. Although all of the crest formations have been depicted herein as continuous, it will be appreciated that they may define breaks thereon such that the castellation are formed from a plurality of individual radially outwardly extending protuberances to provide the outer circumferential surface of the idler 10 with a stippled effect.

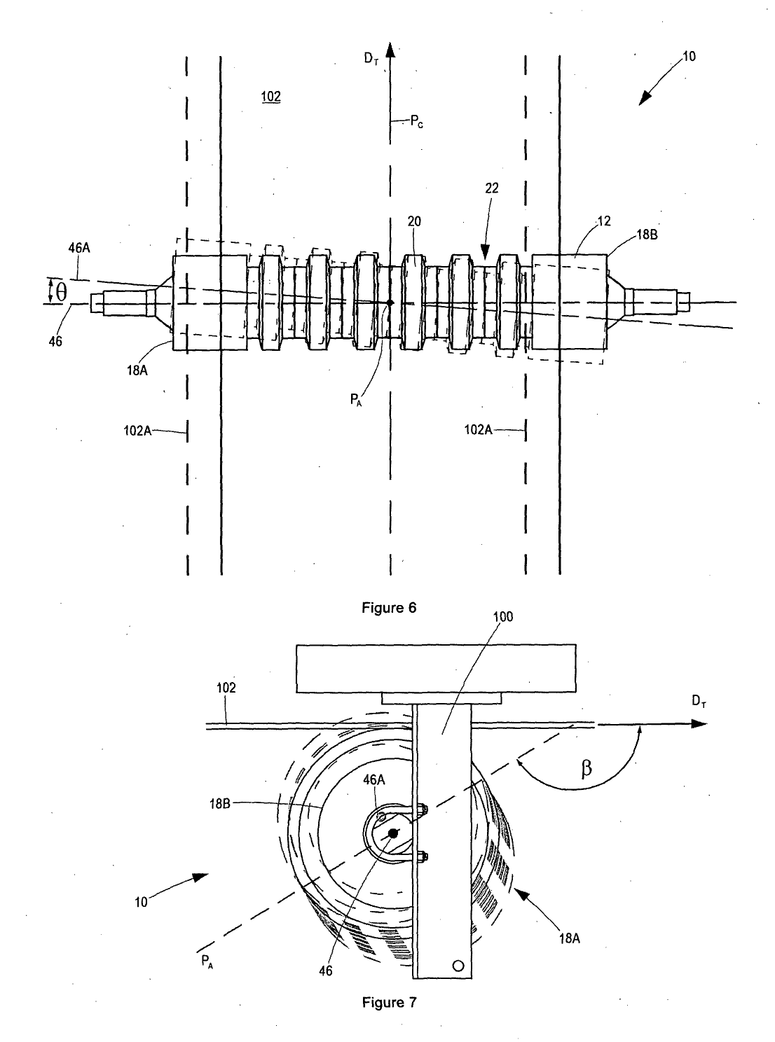

FIG. 6 and FIG. 7 illustrate the steering action of the idler 10 in use. The steering roller 12 is pivotable on the pivot shaft 30 about a pivot axis P_{A}, limited only by abutment of the support axle 14 and the axial end of the outer sleeve 24. Preferably, the idler 10 is installed on a conveyor support structure 100 such that the pivot axis P_{A} is angularly, displaced operatively backwardly from the direction of travel D_{T} of the conveyor belt 102 by an angle β, typically between about 120 and 130 degrees as illustrated in FIG. 7.

With reference now to FIG. 6, the steering roller 12 is rotatable relative to the support axle 14 about a rotational axis 46.

The conveyor belt 102 is arranged to travel along a path the center of which is indicated by dotted line P_{C}, moving in direction D_{T}. As the conveyor belt 102 drifts off its central path P_{C} toward an operatively left side, as indicated by dotted lines 102A, a higher weight distribution between the axial mid-point of the steering roller 12 and its operatively left axial end 18A acts upon the steering roller 12 as compared to the weight distribution acting on the steering roller 12 between the axial mid-point thereof and its opposite operatively right axial end 18B.

The imbalance in weight distributions across the axial span of the steering roller 12, causes the operatively left axial end 18A to be forced under the weight of the conveyor belt 102 acting upon the steering roller 12 operatively downwards to pivot about pivot axis P_{A}, and consequently causing the operatively left axial end 18A to pivot operatively forwards and inwards towards the central path P_{C} (i.e. toward the right hand side of the conveyor belt 102). It will be appreciated that this action will cause the operatively right axial end 18B to pivot operatively upwardly, backwards and pivotally inwards towards the central path P_{C} (i.e. toward the left hand side of the conveyor belt 102). It will further be appreciated that the reverse action would apply where the conveyor belt drifts from the central path P_{C} towards the right.

As such, the rotational axis 46 of the steering roller 12 is pivotally displaced from a first transverse position, wherein the rotational axis 46 is substantially transverse the central path P_{C}, to a second displaced position, wherein the rotational axis 46A is pivotally displaced by angle θ, thereby to impart a steering action to steer the conveyor belt 102 back towards the central path P_{C}.

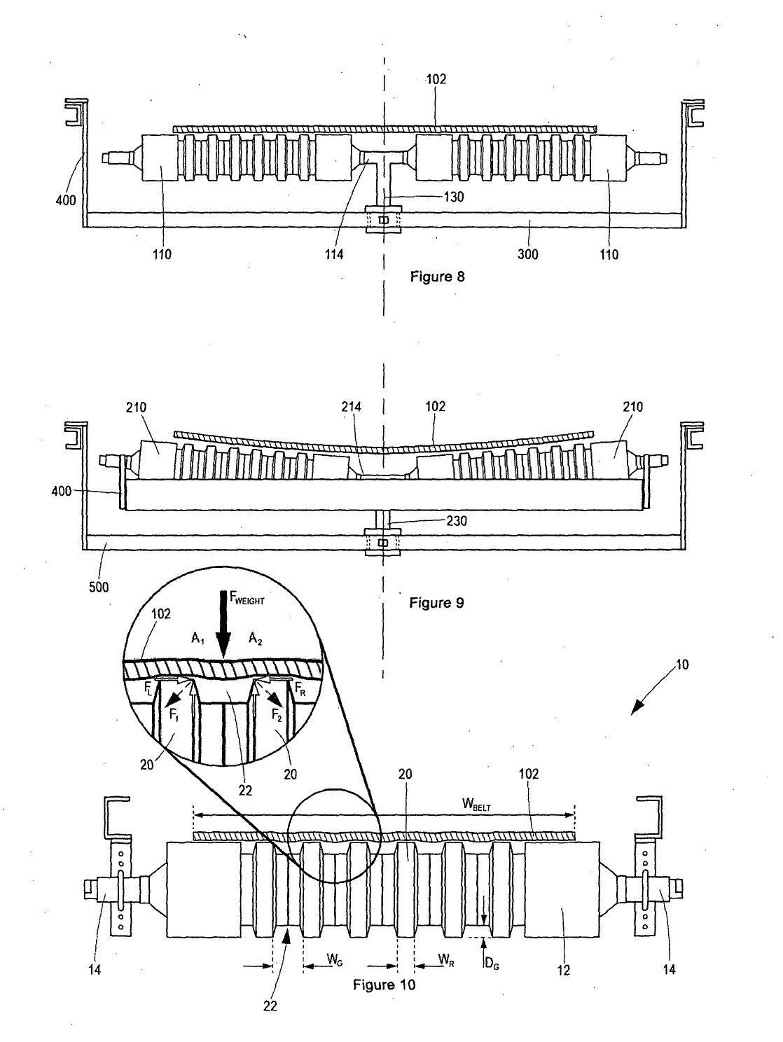

Although the pivot means has been depicted in the embodiment to this point described as being an internal pivot means, it will be appreciated that the pivot means may be external as depicted in FIG. 8 and FIG. 9, with like references numerals designating like components.

In the FIG. 8, the idlers 110 are rotatably mounted on the support axle 114, which support axle 114 is pivotally connected to a support member 300 of a support frame 400 by the pivot shaft 130 to enable pivotal displacement of the rotational axis of the idlers 110.

In the FIG. 9, the idlers 210 are rotatably mounted on the support axle 214, which support axle 214 are mounted on a support frame 400. The support frame 400 is pivotally connected to a conveyor support structure 500 by the pivot shaft 230 to enable pivotal displacement of the rotational axis of the steering rollers 210.

With regards to FIG. 8 and FIG. 9, it will be appreciated that with the pivot means external from the idlers 110,210, such idlers are typically not tracking idlers but normal idlers rotatably supported on the support axle 114,214 by bearing such that their respective axis of rotation is coincident with the longitudinal axis of the support axle 114,214 on which they are supported. It will be appreciated further, that these idlers are typically heavy duty idlers, which although still have castellated formations, may take different shapes to those shown in FIGS. 8 and 9.

Turning back to the preferred embodiment of the idler 10, and with reference to FIG. 10, the enhanced steering action of the steering rollers 12, as provided by the castellated ridges 20 and grooves 22, will now be described in detail.

It will be appreciated the stiffness of a conveyor belt 102 across its width W_{BELT} is a function of its thickness. The thicker the belt, the stiffer the conveyor belt 102 will be across its width W_{BELT}, and vice versa.

To enhance steering action through the castellated ridges 20 and grooves 22 of the steering roller 12, portions of the conveyor belt 102 are required to at least partially sag into respective grooves 22. It will be appreciated that the groove width W_{G} required to cause belt sag is a function of conveyor belt type and thickness and measured axially between proximate apexes A₁,A₂ of adjacent ridges 20.

Through extensive testing, the relationships between groove width W_{G} and the conveyor belt type and thickness have been calculated, which relationship Ranges are set out in the tables that follow.

TABLE 1
Castellation to conveyor belt relationships
for polyester and nylon type belts

| Belt Thickness (mm) | 8-10 | 10-12 | 12-14 | 14-16 | 16-18 |
|---|---|---|---|---|---|
| W_{R} (mm) | 12-14 | 12-14 | 14-16 | 16-18 | 18-20 |
| W_{G} (mm) | 40-50 | 40-50 | 50-60 | 80-100 | 80-100 |
| D_{G} (mm) | 15-20 | 15-20 | 15-20 | 15-20 | 15-20 |

TABLE 2
Castellation to conveyor belt relationships
for polyester and nylon type belts

| Belt Thickness (mm) | 18-20 | 20-22 | 22-25 | 25-30 |
|---|---|---|---|---|
| W_{R} (mm) | 20-22 | 20-25 | 20-25 | 20-25 |
| W_{G} (mm) | 80-100 | 80-100 | 100-150 | 100-150 |
| D_{G} (mm) | 15-20 | 10-15 | 10-15 | 10-15 |

TABLE 3
Castellation to conveyor belt relationships for steel cord belts

| Belt Thickness (mm) | 20-30 | 30-40 | 30-50 |
|---|---|---|---|
| W_{R} (mm) | 25-30 | 25-30 | 30-40 |
| W_{G} (mm) | 100-150 | 100-150 | 150-200 |
| D_{G} (mm) | 10-15 | 10-15 | 10-15 |

TABLE 4
Castellation to conveyor belt relationships
for polyester and nylon type belts

| Belt Thickness (mm) | 8-10 | 10-12 | 12-14 | 14-16 | 16-18 |
|---|---|---|---|---|---|
| W_{R} (mm) | 16-18 | 16-18 | 16-18 | 16-18 | 18-20 |
| W_{G} (mm) | 20-30 | 20-30 | 20-30 | 25-30 | 25-30 |
| D_{G} (mm) | 15-20 | 15-20 | 15-20 | 15-20 | 15-20 |

TABLE 5
Castellation to conveyor belt relationships
for polyester and nylon type belts

| Belt Thickness (mm) | 18-20 | 20-22 | 22-25 | 25-30 |
|---|---|---|---|---|
| W_{R} (mm) | 20-22 | 20-25 | 20-25 | 20-25 |
| W_{G} (mm) | 25-30 | 25-30 | 30-35 | 30-40 |
| D_{G} (mm) | 15-20 | 10-15 | 10-15 | 10-15 |

TABLE 6
Castellation to conveyor belt relationships for steel cord belts

| Belt Thickness (mm) | 20-30 | 30-40 | 30-50 |
|---|---|---|---|
| W_{R} (mm) | 25-30 | 25-30 | 30-40 |
| W_{G} (mm) | 40-50 | 40-50 | 40-50 |
| D_{G} (mm) | 10-15 | 10-15 | 10-15 |

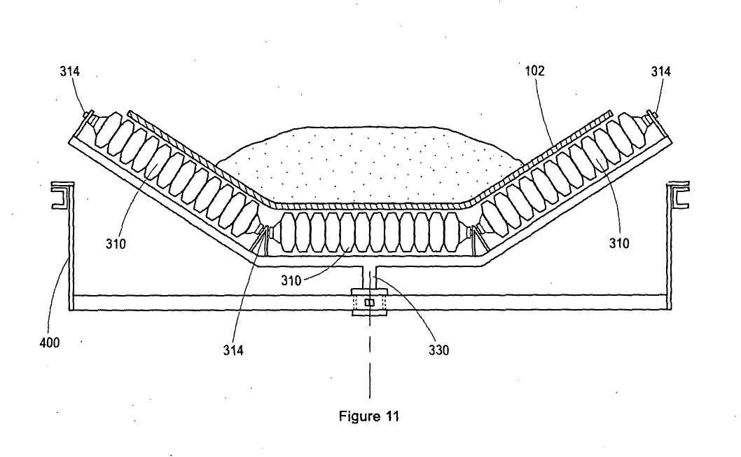

Typically, tables 1 to 3 set out the castellation to conveyor belt relationships for idlers operating in use on the return side of the conveyor belt. Tables 4 to 6 generally set out the castellation to conveyor belt relationships for idlers operating in use on the load carrying side of the conveyor belt as shown in FIG. 11, with like references numerals designating like components.

With the additional load of the material being carried on the load carrying side, the groove widths are normally smaller than on the return side to prevent over sagging or pinching in the conveyor belt.

In use, the sagging of the conveyor belt 102 into the respective grooves requires significant lateral drift of the conveyor belt 102 to dislodge a sagged portion of the conveyor belt 102 from its respective groove 22, with the resistance to dislodgement being more clearly understood with reference to the enlarged view in if FIG. 10.

The weight F_{WEIGHT} of a sagged portion of the conveyor belt 102 spanning across a respective groove 20 is supported on the apexes A₁,A₂ of adjacent ridges 20, causing the weight F_{WEIGHT} of the sagged portion of the conveyor belt 102 to be distributed into the apexes A₁,A₂ of adjacent ridges 20 substantially at right angles to those sagged portion supported by the respective apexes A₁,A₂.

As such, reactive forces of the steering roller 12 to support the sagged conveyor belt are made up of radial force components F₁,F₂ and axial force components F_{L},F_{R}, which axial force components F_{L},F_{R} act axially on the conveyor belt 102 against one another to resist the sagged portion thereof from dislodging from the groove 22. In this manner, the sagged portions of the conveyor belt 102 are forced to run true within a respective groove 22.

It will be appreciated from a study of the tables set out above that other relationship Ranges have also been calculated from extensive testing. For example, suitable ranges of groove depths D_{G} and ridge widths W_{R}.

With reference to FIG. 10, the groove depth D_{G} is measured radially between the apex of a ridge 20 and the radially inner most surface of the groove 22. It is important that the groove depth D_{G} is such that the sagged portions of the conveyor belt do not contact the radially inner most surface of the groove 22, so as to prevent unnecessary wear and the entrapment of grit and grime therein.

Preferably, the ring-shaped lagging 42 is made from a flexible rubber-like material having a coefficient of friction sufficient to ensure traction between it and the conveyor belt 102. Furthermore, the inherent flexibility (preferably a shore hardness of between 50 and 60) thereof will allow, under the compression and decompression of the conveyor belt 102 riding there over, the ridges 20 and the grooves 22 to flex open and closed to release grit and grime therefrom.

Furthermore, the grooves 22 together with air being channelled there through during use acts as tread much the same way as treads on the tyres of automobiles to “blow-out”, exhaust or displace moisture from between the steering roller 12 and the conveyor to increase traction and/or reduce aquaplaning, particularly prevalent during conveyor start ups in wet conditions.

With reference still to FIG. 10, the ridge width W_{R} is measured axially between apexes of one and the same ridge 20, and should be such that the ratio of groove width W_{G} to ridge width W_{R} is within a range of between about 2:1 to 6:1, and/or such that the summed distance of the ridge widths W_{R} of each of the ridges 20 combined is 35% to 55% of the width W_{BELT} of the conveyor belt 102.

Over and above the enhanced steering action provided by the idler 10 in accordance with this invention, which will significantly reduce the risk of damage caused by off running conveyor belts and idler “polishing” (i.e. smooth wearing of the idler) caused by off centre running conveyor belts, other advantages and/or features include:
increased life of idler and/or lagging;
easily replaceable lagging; and
zero run-out balancing to provide vibration free rolling action.

Although the invention has been described above with reference to preferred embodiments, it will be appreciated that many modifications or variations of the invention are possible without departing from the spirit or scope of the invention.

1. An idler for guiding a travelling conveyor belt so that the belt follows a central path, the idler including:
a support axle mountable to a conveyor support structure;
a steering roller rotatably mounted on the support axle so as to be rotatable about a rotational axis thereof;
a pivot means defining a pivot axis about which the rotational axis of the steering roller is pivotally displaceable so as to in use enable the steering roller to impart a steering action upon the conveyor belt to return it to the central path in the event of the conveyor belt drifting laterally from the central path;
wherein a radial periphery of the idler in radial cross-section is castellated to define axially alternating ridges and grooves with the axial distance spanning across a respective groove, and as measured between proximate apexes of adjacent ridges, representing the groove width of such groove; and
further wherein the groove width falls within one of the following Groove Width Ranges:
Groove Width Range A, being between about 20 and 50 millimetres;
Groove Width Range B, being between about 40 and 50 millimetres;
Groove Width Range C, being between about 50 and 70 millimetres;
Groove Width Range D, being between about 70 and 100 millimetres;
Groove Width Range E, being between about 100 and 150 millimetres; or
Groove Width Range F, being between about 150 and 200 millimetres;
so as to in use cause the conveyor belt to at least partially sag into each of the grooves, thereby to increase the steering action of the steering roller on the conveyor belt.

2. An idler according to claim 1, wherein the radial distance between the apex of a respective ridge and the radially inner most surface of a respective groove represents the groove depth, the groove depth falling within one of the following Groove Depth Ranges:
Groove Depth Range A, being between about 15 and 20 millimetres; or
Groove Depth Range B, being between about 10 and 15 millimetres.

3. An idler according to claim 1, wherein the distance spanning between the apexes of a respective ridge, as measured axially along the radial periphery of the idler in radial cross-section, represents the ridge width, the ratio of groove width to ridge width being within a range of about between 1:1 to 6:1.

4. An idler according to claim 3, wherein the summed distance of the ridge widths of each of the ridges combined is 35% to 55% of the width of the conveyor belt to be supported in use thereon.

5. An idler according to claim 4 having a groove width to conveyor belt thickness ratio of between 1.5:1 and 7:1 so as to enable the conveyor belt to at least partially sag into the grooves of the idler on which the conveyor belt is operably supportable.

6-13. (canceled)

14. An idler according to claim 4, wherein the support axle is mounted on a support frame to form an idler assembly mountable on the conveyor support structure, the pivot means being connected between the support axle and the support frame such that the support axle, and consequently the rotational axis of the idler or idlers, is pivotally displaceable relative to the support frame, and in use pivotally displaceable relative to the conveyor support structure and the conveyor belt travelling thereon.

15. An idler according to claim 14, wherein the pivot means is a pivot shaft on which the support axle is pivotally displaceable relative to the support frame.

16. An idler according to claim 4, wherein the support axle is mounted on a support frame to form an idler assembly mountable on the conveyor support structure, the pivot means being connectable between the support frame and the conveyor support structure such that in use the support frame, and consequently the support axle and the rotational axis of the idler or idlers, is pivotally displaceable relative to conveyor support structure and the conveyor belt travelling thereon.

17. An idler according to claim 16, wherein the pivot means is a pivot shaft on which the support frame is pivotally displaceable relative to the conveyor support structure.

18. (canceled)

19. An idler according to claim 4, wherein the steering roller comprises a inner hollow cylindrical sleeve and an outer hollow cylindrical sleeve, the outer sleeve being rotatably mounted on the inner sleeve on bearings located near axial ends of the steering roller, wherein the pivot means is a pivot shaft pivotally connecting the inner sleeve to the support axle at a location coinciding with the axial mid-point of the inner sleeve and the support axle, such that the inner sleeve and the support axle are pivotally displaceable relative to one another about the pivot shaft.

20. An idler according to claim 19, wherein the pivot shaft is connected diametrically across the inner sleeve and passes through a pivot shaft receiving aperture defined in the support axle.

21. An idler according to claim 20, wherein the pivot shaft is fixed in the pivot shaft receiving aperture, with its axial ends received within bushes or bearings mounted diametrically opposite one another on the inner sleeve.

22. An idler according to claim 15, claim 17 or claim 21, wherein the pivot shaft is mounted in use such that it is orientated substantially perpendicularly with respect to the direction of travel of the conveyor belt thereby enabling the rotational axis of the steering roller to pivotally displace about the pivot shaft between a first transverse position, wherein the rotational axis is in use substantially transverse the direction of travel of the conveyor belt to maintain travel of the conveyor belt substantially along the central path, and a second displaced position, wherein the rotational axis is displaced from the first transverse position and urged toward the first transverse position through the steering action of the pivoting steering roller and the sagging of the conveyor belts into the grooves defined thereon.

23. An idler according to claim 22, wherein the pivot shaft is in use orientated angularly backwardly from the direction of travel of the conveyor belt by 90 degrees such that the rotational axis of the steering roller is pivotally displaceable across a plane being substantially parallel to the direction of travel of the conveyor belt.

24. An idler according to claim 22, wherein the pivot shaft is in use orientated angularly backwardly from the direction of travel of the conveyor belt by between about 120 and 130 degrees such that the rotational axis of the steering roller is pivotally displaceable to enable each of the axial ends of the steering roller to move operatively downwards, forwards and inwardly towards the central path of the conveyor belt, or operatively upwards, backwards and pivotally inwardly towards the central path of the conveyor belt to steer the conveyor belt towards the central path.

25-27. (canceled)

28. An idler according to claim 22, wherein the alternating ridges on the idler in radial cross-section are adjacent raised portions of a plurality of annular crest formations spaced axially along the steering roller, and wherein the annular crest formations lie on a perpendicular crest plane being substantially at right-angles with the rotational axis of the steering roller such that the perpendicular crest planes of the respective annular crest formations are parallel relative to one another.

29-32. (canceled)

33. An idler according to claim 22 wherein the castellated alternating ridges and grooves is applied to the steering roller as a lagging, moulded and bonded thereto or secured thereto via connecting channels fixed to the steering roller, the lagging being securable to the connecting channels via corresponding securing formations on the lagging and the channels.

34-43. (canceled)

44. An idler according to claim 5, wherein the groove width to conveyor belt thickness ratio is between 2.5:1 and 6.9:1.

45. An idler according to claim 44, wherein the groove width to conveyor belt thickness ratio is between 3:1 and 6.8:1.

46. An idler according to claim 4 having a groove depth to conveyor belt thickness ratio of between about 0.2:1 and 2.5:1 so as to enable the conveyor belt to at least partially sag into the grooves of the idler on which the conveyor belt is operably supportable without coming into contact with the radially inner most surface of the respective groove.
